(19) United States
(12) Patent Application Publication
(10) Pub. No.: US 2018/0088675 A1
(43) Pub. Date: Mar. 29, 2018

(54) COORDINATE SYSTEM FOR GESTURE CONTROL

(71) Applicants: Brian K. Vogel, Santa Clara, CA (US); Swarnendu Kar, Hillsboro, OR (US)

(72) Inventors: Brian K. Vogel, Santa Clara, CA (US); Swarnendu Kar, Hillsboro, OR (US)

(21) Appl. No.: 15/280,008

(22) Filed: Sep. 29, 2016

(51) Int. Cl. G06F 3/01

(52) U.S. Cl. CPC G06F 3/017; G06F 3/014

(57) ABSTRACT

Embodiments of a system and method for gesture controlled output are generally described. A method may include receiving sensor input information from a wearable device, the sensor input information, determining, using the sensor input information, a gravity vector or a magnetic field, determining a change in horizontal angle, rotational angle, or vertical angle based on the sensor input information, the gravity vector, or the magnetic field, and determining a gesture based on the change in the horizontal angle, the rotational angle, or the vertical angle. The method may include outputting an indication, based on the gesture.

### BACKGROUND

Self-powered wearable electronic devices (wearable devices) have been adapted to a variety of form factors and are becoming increasingly popular with consumer users. A wearable device may include a variety of specialized circuitry and sensors to detect activity such as motion and acceleration. Many wearable devices are limited in their use cases, and provide limited functionality beyond sensor data collection. Typically, wearable devices use an x-y-z coordinate system based on the orientation of the wearable device.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a coordinate system in accordance with some embodiments.

FIG. 2 illustrates a block diagram showing a coordinate transform using sensor inputs in accordance with some embodiments.

FIG. 3 illustrates a dual complementary filter block diagram in accordance with some embodiments.

FIG. 4 illustrates a system for gesture controlled output in accordance with some embodiments.

FIG. 5 illustrates a flowchart showing a technique for gesture controlled output in accordance with some embodiments.

FIG. 6 illustrates generally an example of a block diagram of a machine upon which any one or more of the techniques (e.g., methodologies) discussed herein may perform in accordance with some embodiments.

### DETAILED DESCRIPTION

Systems and methods for gesture controlled output are described herein. The systems and methods described herein may be used to compute gestures from wrist worn device with applications for expressive low latency music creation.

In an example, gesture detection techniques using sensors on a wearable device are described. These techniques may provide low-latency or robust detection of gestures for a wearable musical instrument. The gestures provided by the techniques may be used as base features or gesture building blocks for more general applications outside the music domain, such as gesture controls for a smart watch or other wearable device, games, etc.

In an example, raw data from a device sensor (e.g., an accelerometer, a gyroscope, or a magnetometer) may be used to create a more natural and physically intuitive coordinate system. The intuitive coordinate system may correspond to types of body motion that are possible for a type of device, such as a wrist-worn device. In the wrist-worn device, the device may be worn on the wrist or palm. Other types of device may include devices worn on an ankle, forearm, or the like.

Different types of gestures may be detected, such as tap-type gestures that correspond to specific sudden movements in a particular direction or sudden rotation about a specific axis.

In an example, the systems and methods described herein may use sensors on a wrist-worn device to obtain an estimate of the wrist and forearm orientation. The orientation may be expressed in terms of three types of independent movements that are possible using the muscles of the arm. In another example, various tap gestures may be detected or described in terms of these three types of movements.

Using the systems and techniques described herein may allow for more precise expressive and low-latency musical performance than existing wrist- or palm-worn systems. For example, by estimating a current orientation of a wearable device in terms of easily-performed independent arm movements (e.g., a wrist rotation, a vertical forearm angle, or a horizontal forearm angle), a system may output using low latency and fast responses to changes in the device orientation. The techniques described herein may use a gyroscope of a wearable device to obtain fast and low latency responses to changes in device orientation. In an example, the gyroscope data may be combined with information from an accelerometer or a magnetometer to compensate for gyroscope drift.

When worn on the wrist, the systems and methods described herein provide an orientation of a forearm in a wrist-centric coordinate system. When worn in other ways (e.g., on an ankle, foot, elbow, head, etc.), the orientation provided by the systems and methods herein provides a coordinate system specific to the part of the body on which the device is attached.

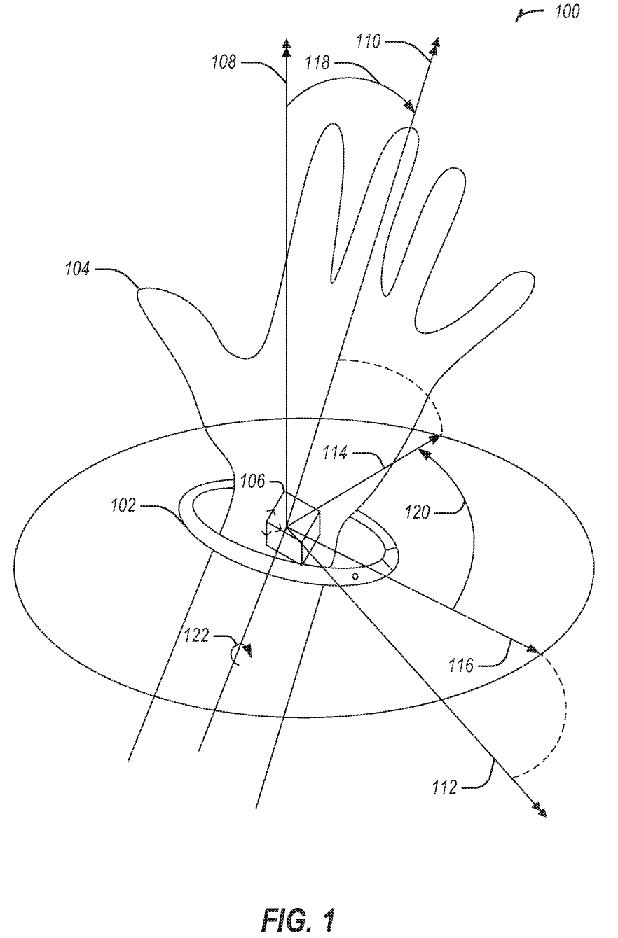

FIG. 1 illustrates a coordinate system 100 in accordance with some embodiments. The coordinate system 100 includes a wearable device 102 attached to a user 104. The wearable device 102 may include a sensor or sensors to accurately output orientation, velocity, acceleration, etc., of the wearable device.

The coordinate system allows the user 104 to receive information about an orientation of a specific body part (such as a forearm) in space, rather than the orientation of the device that is being worn on the forearm. For example, for a wrist-worn device, there may be three basic easily performed and independent types of movement.

In an example, the coordinate system 100 may include a transformation of data received from sensors of the wearable device 102 to a useable coordinate system that is understandable by the user 104. The user 104 orientation coordinate system 100 may include a wrist or forearm rotation angle 122, a vertical wrist or forearm rotation angle 118, and a horizontal wrist or forearm rotation angle 120.

The wrist or forearm rotation angle 122 may include the rotation angle about a line that connects the elbow to the wrist. The wrist or forearm rotation angle 122 may roughly correspond to the rotation the wrist makes when a knob is turned. In an example, a first example of the wrist or forearm rotation angle 122 may include providing an angle of the palm with the direction of gravity (e.g., gravity vector 108), for example, such that palm-down corresponds to 0 degrees, and the angle increases as the wrist is rotated (e.g., 180 degrees when the palm faces upward). The first example is defined when the forearm is approximately parallel to the floor, but may include a discontinuity when the forearm is aligned with the gravity vector 108. The second example for the wrist or forearm rotation angle 122 includes obtaining the rotation about the forearm axis 110, which may not have discontinuities.

The vertical wrist or forearm rotation angle 118 includes a rotation angle of the forearm in the vertical direction with respect to the floor. For example, the vertical wrist or forearm rotation angle 118 may be mapped such that an arm at the side of the user 104 with the hand of the user 104 pointed down may correspond to 0 degrees, reaching 90 degrees as the forearm is rotated up so that it is parallel to the floor with the hand pointed straight out, and reaching 180 degrees as the forearm rotates straight up with hand pointed toward the sky (e.g., coincident with the gravity vector 108).

The horizontal wrist or forearm rotation angle 120 may include a rotation angle of the forearm in the horizontal direction, such as the angle formed when the forearm is projected into the horizontal plane (e.g., the plane parallel to a floor). The horizontal wrist or forearm rotation angle 120 may be calculated with respect to a reference angle, such as a magnetic projection 116 or a user-calibrated direction. This angle will therefore decrease or increase as the user 104 holds the elbow steady while rotating the hand left or right. The horizontal wrist or forearm rotation angle 120 may include an angle between a forearm projection 114 of the forearm axis 110 onto the gravity vector 108 and a magnetic projection 116 of the magnetic north axis 112 onto the gravity vector 108.

In an example, the three angles (e.g., the wrist or forearm rotation angle 122, the vertical wrist or forearm rotation angle 118, and the horizontal wrist or forearm rotation angle 120) are orthogonal (e.g., completely independent) such that any one of the angles may be changed without affecting the other angles. For example, if only the wrist is rotated, the vertical and horizontal angle may not change.

In an example, the coordinate system 100 is more intuitive to the user 104 than the xyz coordinate system 106. In an example, the wearable device 102 is worn on the wrist. When worn on the wrist, when the forearm is parallel to the floor (e.g., with the hand pointed out away from the body with the palm facing down), the device x-axis points to the right, the device y-axis points out (e.g., parallel to forearm), and the device z-axis points up (e.g., parallel to gravity direction). With this orientation, if the user 104 rotates the hand left or right slightly, a rotation may be registered about the z-axis and acceleration may be registered along the x-axis. When the user 104 rotates the wrist 90 degrees clockwise so that the palm now faces left (e.g., the hand is in a karate-chop position), and when the user repeats the slight left-right motion of the hand, the rotation and acceleration are along a completely different wearable device 102 axis within the xyz coordinate system 106. That is, instead of about the z-axis, the rotation will be mainly about the x-axis, and instead of acceleration along the x-axis, the acceleration will be mainly along the z-axis. Thus, the same left-right movement with a simple 90 degree rotation of the wrist completely changed the wearable device 102 axes on which the observed motion occurred, This result may be counter-intuitive or confusing to the user 104. In the coordinate system 100, the same rotation about the horizontal-angle axis and the same acceleration along the horizontal-axis direction would occur when the hand is moved slightly left-right, regardless of the position of the hand or wrist. In the coordinate system 100, the only difference between the two gestures described above is that the wrist angle may differ by 90 degrees. When the gesture is determined based on relative movement, the difference of 90 degrees may be discarded.

In an example, various gestures may be defined. For example, gestures used in the coordinate system 100 may be easier to understand or describe in the coordinate system 100 than in the xyz coordinate system 106 of the wearable device 104. The gestures may include tap gestures that correspond to acceleration or rotation with respect to the coordinate system 100. For example, a gesture may include a down tap. The down tap gesture may be a quick motion of the hand or wrist in a downward direction (e.g., toward the floor). This gesture corresponds to a quick change in the vertical wrist or forearm rotation angle 118 or acceleration along the line of the gravity vector 108. In this gesture, the wrist or forearm rotation angle 122 and the horizontal wrist or forearm rotation angle 120 may not change or may not be considered when determining if the down tap gesture has occurred.

In another example, the gestures include a right tap gesture. This gesture includes a quick motion of the hand or in the right direction. This gesture corresponds to a quick change in the horizontal wrist or forearm rotation angle 120 as well as an acceleration perpendicular to both the gravity vector 108 and the forearm axis 110. In this gesture, the wrist or forearm rotation angle 118 and the vertical wrist or forearm rotation angle 118 may not change or may not be considered when determining if the down tap gesture has occurred.

In another example, the gestures include an out tap gesture. This gesture includes a quick motion of the hand or wrist in the outward direction (e.g., along the forearm axis 110, as if punching). This gesture corresponds to a quick change in the forearm axis 110 acceleration. In this gesture, the wrist or forearm rotation angle 122, the horizontal wrist or forearm rotation angle 120, and the vertical wrist or forearm rotation angle 118 may not change or may not be considered when determining if the down tap gesture has occurred.

In an example, the gestures include a twist tap gesture. This gesture includes a quick rotation of the wrist, either in the clockwise or counter-clockwise direction. This gesture corresponds to a change in the wrist or forearm rotation angle 122. In this gesture, the horizontal wrist or forearm rotation angle 120 and the vertical wrist or forearm rotation angle 118 may not change or may not be considered when determining if the down tap gesture has occurred.

In an example, the gestures include an omni-tap gesture. This gesture includes a quick movement of the hand or wrist in any direction. In this gesture, the angles 118, 120, and 122 may be used.

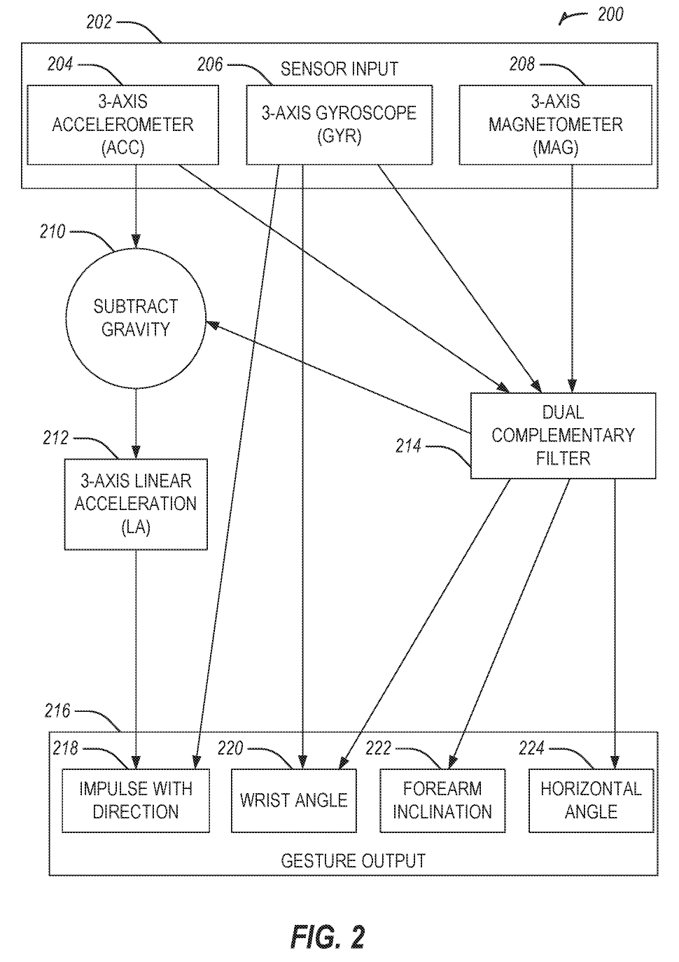

FIG. 2 illustrates a block diagram 200 showing a coordinate transform using sensor input 202 in accordance with some embodiments. The block diagram 200 illustrates a high-level process flow of the coordinate transformation. The sensor input 202 may include input from a plurality of sensors. The plurality of sensors may include a 3-axis accelerometer 204, a 3-axis gyroscope 206, or a 3-axis magnetometer 208. The coordinate transform may result in gesture outputs 216, such as an impulse with direction 218, a wrist angle 220, a forearm inclination 222, or a horizontal angle 224.

In an example, the impulse with direction 218 is determined using information ultimately from the 3-axis gyroscope 206 and the 3-axis accelerometer 204. The information from the 3-axis accelerometer 204 may be modified to subtract gravity 210, resulting in a 3-axis linear acceleration 212. The impulse with direction 218 may be determined using the 3-axis linear acceleration 212. To subtract gravity 210, a dual complementary filter 214 may be used. The dual complementary filter 214 may be calculated using the 3-axis accelerometer 204, the 3-axis gyroscope 206, and the 3-axis magnetometer 208.

In another example, the wrist angle 220 may be determined based on information from the 3-axis gyroscope 206 and the dual complementary filter 214. The forearm inclination 222 or the horizontal angle 224 may be determined based on information from the dual complementary filter 214.

In an example, the input sensor data 202 may include a 9-axis sensor, which may include an X, Y, Z axis each for an accelerometer, a gyroscope, and a magnetometer. The dual complementary filter 214 may be used to obtain estimates of the gravity direction or the magnetic field direction. The gyroscope may be used to keep the orientation accurate even under fast device rotations. In addition to the dual complementary filter 214, the linear acceleration 212 may be calculated, such as by removing acceleration due to gravity from the device acceleration. A tap detector module may use the transformed coordinates or linear acceleration as input signals.

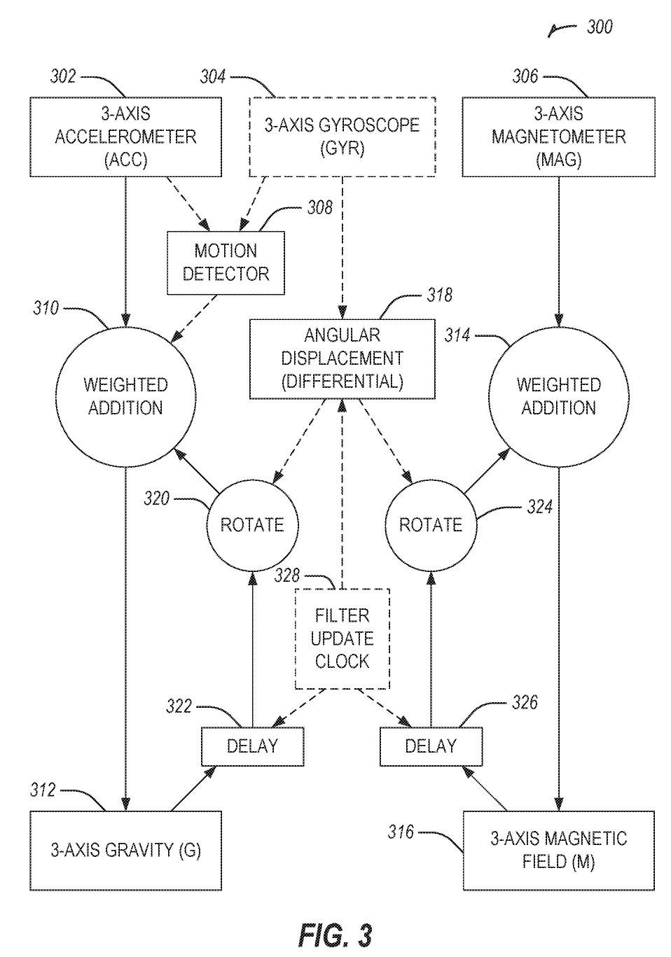

FIG. 3 illustrates a dual complementary filter block diagram 300 in accordance with some embodiments. The dual complementary filter block diagram 300 may be used, for example, in FIG. 2 as the dual complementary filter 214.

In an example, a preliminary step in obtaining the coordinate transformation is to obtain robust estimates of the device with respect to both gravity and the magnetic field of the Earth. The dual complementary filter block diagram 300 receives information from the 3-axis accelerometer 302, the 3-axis magnetometer 306, and optionally the 3-axis gyroscope 304.

The dual complementary filter block diagram 300 uses the 3-axis accelerometer 302 and the 3-axis magnetometer 306 or similar sensors to track the gravity and the magnetic field directions of the Earth. The 3-axis gyroscope 304 may be used to accurately track the gravity and the magnetic field under rapid device rotation. When the gyroscope is not used, the gravity or magnetic field estimates may be noisy or the estimates may respond slowly under rapid device rotation.

The 3-axis accelerometer 302 may be used optionally with the 3-axis gyroscope 304 by a motion detector 308 to determine motion, which may be combined with the 3-axis accelerometer 302 to determine a weighted addition 310. The weighted addition 310 may include a rotational component 320, determined using a delayed feedback 322. The weighted addition 310 may output a 3-axis gravity value 312. The 3-axis gravity value 312 may be used with the delayed feedback 322, which may be optionally updated from a filter update clock 328. The rotational component 320 may optionally include an angular displacement (differential) 318. The angular displacement (differential) 318 may be determined using the 3-axis gyroscope 304 and the filter update clock 328.

The 3-axis magnetometer 306 may be used to determine a weighted addition 314. The weighted addition 314 may include a rotational component 324, determined using a delayed feedback 326. The weighted addition 314 may output a 3-axis magnetic field 316. The 3-axis magnetic field 316 may be used with the delayed feedback 326, which may be optionally updated from the filter update clock 328. The rotational component 324 may optionally include the angular displacement (differential) 318.

The dual complementary filter may performs sensor fusion of the gyroscope and accelerometer using a weighted average of both, as described in Eq. 1, below.

Gₜ=U{(1−α_{g})R{Gₜ₋₁·GYRₜ,dt}+α_{g}U{ACCₜ}} Eq. 1

In Eq. 1, the ACCₜ is the raw sensor readings from the 3-axis accelerometer 302, scaled to mt/seĉ2, GYRₜ is the raw sensor readings from the 3-axis gyroscope 304, scaled to rad/sec, and dt is the sampling duration in seconds. In an example, α_{g} is typically a small scalar, such as 0.02 for example, chosen to compensate for long-term gyroscope drifts. In an example, the value is chosen large enough that the accelerometer component is larger than the gyro noise signal. Gₜ is a real-time estimate of the gravity direction, such that if the device is not moving, the accelerometer and gravity state point to the same direction and differ by magnitude ACCₜ=Gₜ×9.81 m/sec².

Eq. 1 includes U { . . . } denoting an operator that extracts only the direction of a vector by making it unit magnitude U(x)=x/√(x′x), R{x, θ} denoting the 3-dimensional rotation of a vector, and R{{Gₜ₋₁·GYRₜ,dt} denoting the filtered gravity vector from the previous sample rotated by the current gyroscope rotation using a quaternion rotation. In an example, U{ACCₜ} is the accelerometer sensor normalized to a unit vector. The gravity state vector Gₜ may be normalized to be a unit vector.

In an example, another independent complementary filter may be used to track the direction of the magnetic field, as described in Eq. 2, below.

Mₜ=U{(1−αₘ)R{Mₜ₋₁·GYRₜ,dt}+αₘU{MAGₜ}} Eq. 2

Eq. 2 includes, in an example, am as a small scalar close to zero, such as 0.02 for example. The value may be chosen large enough that the magnetic component is larger than the gyro noise signal. In an example, R{Mₜ₋₁·GYRₜ,dt} is the filtered magnetic vector from the previous sample rotated by the current gyroscope rotation using a quaternion rotation. In an example, MAGₜ may be the magnetic sensor normalized to a unit vector. The magnetic field state Mₜ may be normalized to be a unit vector.

The horizontal angle may be denoted as θ_{H}. The horizontal angle may be determined using both the gravity and magnetic complementary filters as inputs. This angle may be computed using Eqs. 3 and 4, as described below. In Eq. 3, PROJ_{G}⊥(Y) may be the projection of the forearm axis onto the horizontal plane. For example, if the device y-axis is aligned with the line connecting the elbow to the wrist, then the forearm axis may be equivalent to the device y-axis.

PROJ_{G}⊥(Y)=Y−PROJ_{G}(Y) Eq. 3

PROJ_{G}(Y)=(G,Y)G Eq. 4

In Eqs 5 and 6, PROJ_{G}⊥(M) may be the projection of the magnetic field (e.g., onto the horizontal plane).

PROJ_{G}⊥(M)=M−PROJ_{G}(Y) Eq. 5

PROJ_{G}(M)=(G,M)G Eq. 6

An error may be introduced when the magnetic field and the gravity direction of the Earth are collinear, which rarely occurs on Earth (e.g., potentially at the poles).

The horizontal angle θ_{H} may be computed, such as in the range [0, 360) in the horizontal plane, between PROJ_{G}⊥(Y) and PROJ_{G}⊥(M).

In another example, the horizontal angle θ_{H} may be determined without a magnetic sensor. In the case where the device does not have a magnetic sensor or the local magnetic field is too distorted to be usable, an alternative technique may be used to compute the horizontal angle. Since there is no reference, an arbitrary starting angle may be selected, such as 0 degrees for the first estimate. Without magnetic information, the estimate may slowly drift over time as gyroscope drift errors accumulate. To combat this drift, the gyroscope data may be compensated for bias and drifts may be relatively small, such as 1 degree per minute.

To determine the horizontal angle θ_{H} without a magnetic sensor, the gyroscope rotation vector may be projected onto filtered gravity to obtain the device rotation about the gravity direction G, which is the rotation in the horizontal plane, as described in Eq. 7, below.

horizontal_rotation=<gyroscope, G> Eq. 7

The horizontal angle θ_{H} may be determined by integrating for 1 sample to obtain a new horizontal rotation estimate, as described in Eq. 8, below.

horizontal_rotation+=horizontal_rotation*sample_period Eq. 8

In an example, the wrist angle may be denoted by θ_{w}. In an example, a first technique for determining the wrist angle may include determining the wrist angle from the filtered gravity direction. Assuming Y to be the forearm direction and X, Z the remaining two orthogonal sensor coordinates, Eq. 9, below, may be used to estimate the wrist angle.

wrist_angle=atan2(G^{X}, G^{Z}), Eq. 9

In Eq. 9, G^{X} may point up when the palm points down and G^{Z} may point right when the palm points down.

In another example, a second technique for determining the wrist angle may include determining the wrist angle without an absolute reference angle for the forearm. For example, the user initializes 0 degrees with some initial forearm position. Then the angle of the forearm may be computed by integrating the forearm-axis gyroscope. The computed angle may drift slowly depending on the quality of the gyroscope that is used. This method of wrist angle may be well-suited to using as the input to the wrist rotation tap gesture detector.

The vertical angle may be denoted by θ_{V}. In an example, the forearm angle may be defined as the angle between the filtered gravity direction and the device forearm axis as described in Eq. 10, below.

forearm_angle=compute_angle(Y, G) Eq. 10

The linear acceleration may be denoted by LA. The device linear acceleration may be determined from Eq. 11, below.

LA=ACC_G*9.81 m/seĉ2 Eq. 11

A variety of techniques may be used to detect tap events or directional impulse events, as described below. A down-tap may be computed by computing the projection of the linear acceleration in the filtered gravity direction and then performing simple peak finding to trigger a tap event with magnitude proportional to peak height. A down-tap may also be computed by computing the amount of rotation in the vertical forearm direction and using finding peaks in this signal. A right tap may be computed either by using the device linear acceleration in the horizontal plane direction or using the projection of the gyroscope rotation in the horizontal angle direction. A wrist-tap may be computed by projection the device rotation along the forearm axis and find peaks in this signal. An omni-tap (e.g., any direction tap) may be computed by finding peaks in the magnitude of the linear acceleration and then preventing detections for a short time unless subsequent magnitude peaks or in a similar direction to the first-detected peak. This technique to detect an omni-tap may prevent false detections from the positive and negative acceleration swings along the same line in space.

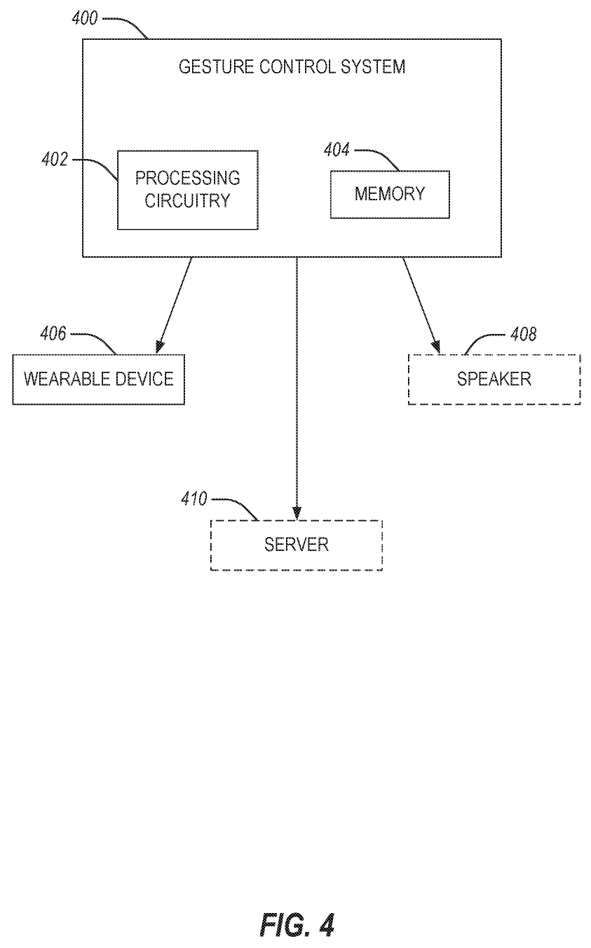

FIG. 4 illustrates a system 400 for gesture controlled output in accordance with some embodiments. The system 400 includes processing circuitry 402 and memory 404. The system 400 connects with a wearable device 406. In an example, not shown in FIG. 4, the system 400 operates on the wearable device 406. The system 400 may connect with a speaker 408 or a server 410.

The processing circuitry 402 may be used to receive sensor input information from the wearable device 406. The sensor input information may include accelerometer data, gyroscope data, or magnetometer data. The wearable device 406 may include an accelerometer, gyroscope, or magnetometer to supply the sensor input to the processing circuitry 402. The wearable device 406 may be a wrist-worn device.

The processing circuitry 402 may determine, using the sensor input information, a gravity vector or a magnetic field. The processing circuitry 402 may determine a change in horizontal angle, rotational angle, or vertical angle based on the sensor input information, the gravity vector, or the magnetic field. In an example, the processing circuitry 402 may determine a gesture based on the change in the horizontal angle, the rotational angle, or the vertical angle. To determine the gesture, the processing circuitry 402 may use the accelerometer data to determine a three-axis linear acceleration vector. The three-axis linear acceleration vector or the gyroscope data may be used to determine a directional impulse vector. In another example, to determine the gesture, the processing circuitry 402 may determine a wrist angle using the gyroscope data or the gravity vector. In yet another example, to determine the gesture, the processing circuitry 402 may determine a forearm inclination using the gravity vector. In an example, to determine the gesture, the processing circuitry 402 may determine a horizontal angle using the gravity vector and the magnetic field. In an example, the gravity vector may be determined using a weighted average of at least one of the sensor inputs or a previous gravity vector. In an example, the magnetic field may be determined using a weighted average of at least one of the sensor inputs or a previous magnetic field.

In an example, the gesture may include a down tap, a right tap, an out tap, a twist tap, or an omni-tap. The processing circuitry 402 may, in an example, output an indication, based on the gesture. The indication may include instructions for playing sound. For example, the indication may be sent to the speaker 408 for playing the sound. To play sound, the processing circuitry 402 may receive sound from the server 410 based on an identified gesture. In an example, the processing circuitry 402 may send instructions to the speaker 408 to play a specific instrument corresponding to a detected gesture. The processing circuitry 402 may determine an initial state of the wearable device 406. The change in the horizontal angle, the rotational angle, or the vertical angle may include a change from the initial state.

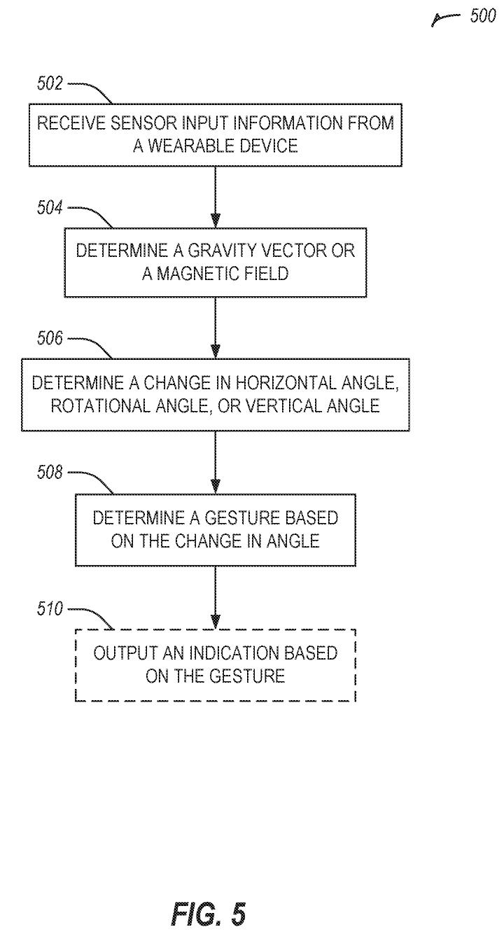

FIG. 5 illustrates a flowchart showing a technique 500 for gesture controlled output in accordance with some embodiments. The technique 500 includes an operation 502 to receive sensor input information from a wearable device. In an example, the wearable device is a wrist-worn device. The sensor input information may include accelerometer data, gyroscope data, or magnetometer data.

The technique 500 includes an operation 504 to determine a gravity vector or a magnetic field. In an example, the gravity vector is determined using a weighted average of at least one of the sensor inputs or a previous gravity vector. In another example, the magnetic field. is determined using a weighted average of at least one of the sensor inputs or a previous magnetic field.

The technique 500 includes an operation 506 to determine a change in horizontal angle, rotational angle, or vertical angle. The change in angles may be determined based on the sensor input information, the gravity vector, or the magnetic field.

The technique 500 includes an operation 508 to determine a gesture based on the change in angle. To determine the change in angle, the technique 500 may use the accelerometer data to determine a three-axis linear acceleration vector. The three-axis linear acceleration vector may be used, for example with the gyroscope data, to determine a directional impulse vector. The directional impulse vector may be used to determine a type of gesture, such as a tap gesture. In an example, determining the gesture includes determining a wrist angle using the gyroscope data and the gravity vector. In another example, determining the gesture includes determining a forearm inclination using the gravity vector. In yet another example, determining the gesture includes determining a horizontal angle using the gravity vector and the magnetic field. The gesture may include a tap gesture, such as a down tap, a right tap, an out tap, a twist tap, or an omni tap.

The technique 500 may include an optional operation 510 to output an indication based on the gesture. In an example, the indication includes instructions for playing sound. In an example, the instructions for playing sound may include instructions for playing a specific instrument corresponding to the gesture. To output the indication, the optional operation 510 may include sending the indication to speakers to play the sound. The technique may include an operation to determine an initial state of the wearable device. The change in the horizontal angle, the rotational angle, or the vertical angle may include a change from the initial state.

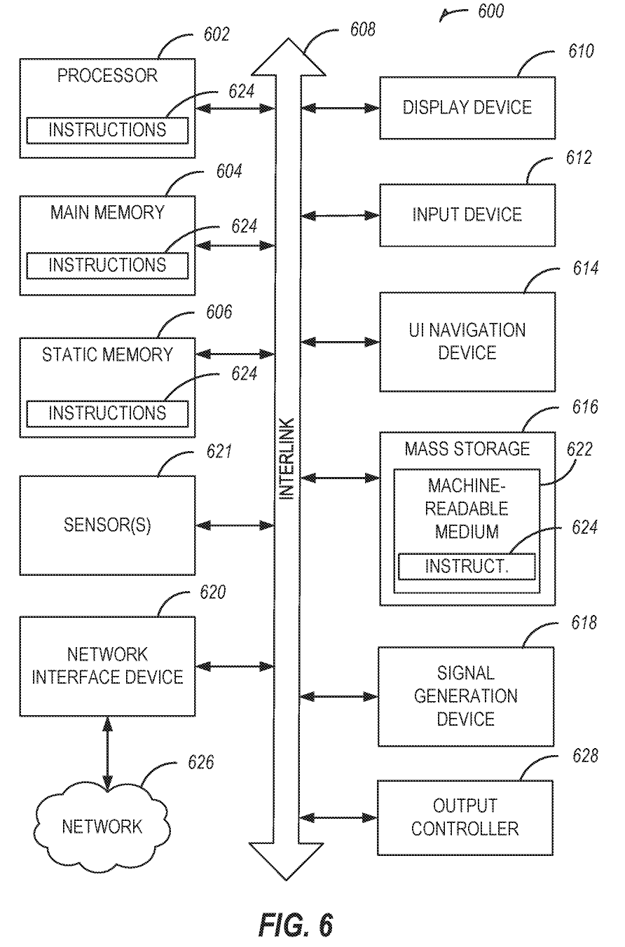

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### Various Notes & Examples

Each of these non-limiting examples may stand on its own, or may be combined in various permutations or combinations with one or more of the other examples.

Example 1 is a device for gesture controlled output, the device including processing circuitry to: receive sensor input information from a wearable device, the sensor input information including accelerometer data, gyroscope data, and magnetometer data; determine, using the sensor input information, a gravity vector and a magnetic field; determine a change in horizontal angle, rotational angle, or vertical angle based on the sensor input information, the gravity vector, and the magnetic field; determine a gesture based on the change in the horizontal angle, the rotational angle, or the vertical angle; and output an indication, based on the gesture, the indication including instructions for playing sound.

In Example 2, the subject matter of Example 1 optionally includes wherein the processing circuitry is further to determine an initial state of the wearable device and wherein the change in the horizontal angle, the rotational angle, or the vertical angle includes a change from the initial state.

In Example 3, the subject matter of any one or more of Examples optionally include wherein to determine the gesture, the processing circuitry is to use the accelerometer data to determine a three-axis linear acceleration vector.

In Example 4, the subject matter of Example 3 optionally includes wherein to determine the gesture, the processing circuitry is to determine a directional impulse vector using the three-axis linear acceleration and the gyroscope data.

In Example 5, the subject matter of any one or more of Examples 1-4 optionally include wherein to determine the gesture, the processing circuitry is to determine a wrist angle using the gyroscope data and the gravity vector.

In Example 6, the subject matter of any one or more of Examples 1-5 optionally include wherein to determine the gesture, the processing circuitry is to determine a forearm inclination using the gravity vector.

In Example 7, the subject matter of any one or more of Examples 1-6 optionally include wherein to determine the gesture, the processing circuitry is to determine a horizontal angle using the gravity vector and the magnetic field.

In Example 8, the subject matter of any one or more of Examples 1-7 optionally include wherein the gesture includes one of a down tap, a right tap, an out tap, a twist tap, or an omni tap.

In Example 9, the subject matter of any one or more of Examples 1-8 optionally include wherein the instructions for playing sound include instructions for playing a specific instrument corresponding to the gesture.

In Example 10, the subject matter of any one or more of Examples 1-9 optionally include wherein the wearable device is a wrist-worn device.

In Example 11, the subject matter of any one or more of Examples 1-10 optionally include wherein the gravity vector is determined using a weighted average of at least one of the sensor inputs and a previous gravity vector.

In Example 12, the subject matter of any one or more of Examples 1-11 optionally include wherein the magnetic field is determined using a weighted average of at least one of the sensor inputs and a previous magnetic field.

In Example 13, the subject matter of any one or more of Examples 1-12 optionally include wherein to output the indication, the processing circuitry is to send the indication to speakers to play the sound.

Example 14 is a method for gesture controlled output, the method comprising: receiving sensor input information from a wearable device, the sensor input information including accelerometer data, gyroscope data, and magnetometer data; determining, using the sensor input information, a gravity vector and a magnetic field; determining a change in horizontal angle, rotational angle, or vertical angle based on the sensor input information, the gravity vector, and the magnetic field; determining a gesture based on the change in the horizontal angle, the rotational angle, or the vertical angle; and outputting an indication, based on the gesture, the indication including instructions for playing sound.

In Example 15, the subject matter of Example 14 optionally includes determining an initial state of the wearable device and wherein the change in the horizontal angle, the rotational angle, or the vertical angle includes a change from the initial state.

In Example 16, the subject matter of any one or more of Examples 14-15 optionally include wherein determining the change includes using the accelerometer data to determine a three-axis linear acceleration vector.

In Example 17, the subject matter of Example 16 optionally includes wherein determining the gesture includes determining a directional impulse vector using the three-axis linear acceleration and the gyroscope data.

In Example 18, the subject matter of any one or more of Examples 14-17 optionally include wherein determining the gesture includes determining a wrist angle using the gyroscope data and the gravity vector.

In Example 19, the subject matter of any one or more of Examples 14-18 optionally include wherein determining the gesture includes determining a forearm inclination using the gravity vector.

In Example 20, the subject matter of any one or more of Examples 14-19 optionally include wherein determining the gesture includes determining a horizontal angle using the gravity vector and the magnetic field.

In Example 21, the subject matter of any one or more of Examples 14-20 optionally include wherein the gesture includes one of a down tap, a right tap, an out tap, a twist tap, or an omni tap.

In Example 22, the subject matter of any one or more of Examples 14-21 optionally include wherein the instructions for playing sound include instructions for playing a specific instrument corresponding to the gesture.

In Example 23, the subject matter of any one or more of Examples 14-22 optionally include wherein the wearable device is a wrist-worn device.

In Example 24, the subject matter of any one or more of Examples 14-23 optionally include wherein the gravity vector is determined using a weighted average of at least one of the sensor inputs and a previous gravity vector.

In Example 25, the subject matter of any one or more of Examples 14-24 optionally include wherein the magnetic field is determined using a weighted average of at least one of the sensor inputs and a previous magnetic field.

In Example 26, the subject matter of any one or more of Examples 14-25 optionally include wherein outputting the indication includes sending the indication to speakers to play the sound.

Example 27 is at least one machine-readable medium including instructions for operation of a computing system, which when executed by a machine, cause the machine to perform operations of any of the methods of Examples 14-26.

Example 28 is an apparatus comprising means for performing any of the methods of Examples 14-26.

Example 29 is an apparatus for gesture controlled output, the apparatus comprising: means for receiving sensor input information from a wearable device, the sensor input information including accelerometer data, gyroscope data, and magnetometer data; means for determining, using the sensor input information, a gravity vector and a magnetic field; means for determining a change in horizontal angle, rotational angle, or vertical angle based on the sensor input information, the gravity vector, and the magnetic field; means for determining a gesture based on the change in the horizontal angle, the rotational angle, or the vertical angle; and means for outputting an indication, based on the gesture, the indication including instructions for playing sound.

In Example 30, the subject matter of Example 29 optionally includes means for determining an initial state of the wearable device and wherein the change in the horizontal angle, the rotational angle, or the vertical angle includes a change from the initial state.

In Example 31, the subject matter of any one or more of Examples 29-30 optionally include wherein the means for determining the change include means for using the accelerometer data to determine a three-axis linear acceleration vector.

In Example 32, the subject matter of Example 31 optionally includes wherein the means for determining the gesture include means for determining a directional impulse vector using the three-axis linear acceleration and the gyroscope data.

In Example 33, the subject matter of any one or more of Examples 29-32 optionally include wherein the means for determining the gesture include means for determining a wrist angle using the gyroscope data and the gravity vector.

In Example 34, the subject matter of any one or more of Examples 29-33 optionally include wherein the means for determining the gesture include means for determining a forearm inclination using the gravity vector.

In Example 35, the subject matter of any one or more of Examples 29-34 optionally include wherein the means for determining the gesture include means for determining a horizontal angle using the gravity vector and the magnetic field.

In Example 36, the subject matter of any one or more of Examples 29-35 optionally include wherein the gesture includes one of a down tap, a right tap, an out tap, a twist tap, or an omni tap.

In Example 37, the subject matter of any one or more of Examples 29-36 optionally include wherein the instructions for playing sound include instructions for playing a specific instrument corresponding to the gesture.

In Example 38, the subject matter of any one or more of Examples 29-37 optionally include wherein the wearable device is a wrist-worn device.

In Example 39, the subject matter of any one or more of Examples 29-38 optionally include wherein the gravity vector is determined using a weighted average of at least one of the sensor inputs and a previous gravity vector.

In Example 40, the subject matter of any one or more of Examples 29-39 optionally include wherein the magnetic field is determined using a weighted average of at least one of the sensor inputs and a previous magnetic field.

In Example 41, the subject matter of any one or more of Examples 29-40 optionally include wherein the means for outputting the indication include means for sending the indication to speakers to play the sound.

Example 42 is at least one machine-readable medium including instructions for operation of a computing system, which when executed by a machine, cause the machine to: receive sensor input information from a wearable device, the sensor input information including accelerometer data, gyroscope data, and magnetometer data; determine, using the sensor input information, a gravity vector and a magnetic field; determine a change in horizontal angle, rotational angle, or vertical angle based on the sensor input information, the gravity vector, and the magnetic field; determine a gesture based on the change in the horizontal angle, the rotational angle, or the vertical angle; and output an indication, based on the gesture, the indication including instructions for playing sound.

In Example 43, the subject matter of Example 42 optionally includes instructions to determine an initial state of the wearable device and wherein the change in the horizontal angle, the rotational angle, or the vertical angle includes a change from the initial state.

In Example 44, the subject matter of any one or more of Examples 42-43 optionally include wherein the instructions to determine the change include instructions to use the accelerometer data to determine a three-axis linear acceleration vector.

In Example 45, the subject matter of Example 44 optionally includes wherein the instructions to determine the gesture include instructions to determine a directional impulse vector using the three-axis linear acceleration and the gyroscope data.

In Example 46, the subject matter of any one or more of Examples 42-45 optionally include wherein the instructions to determine the gesture include instructions to determine a wrist angle using the gyroscope data and the gravity vector.

In Example 47, the subject matter of any one or more of Examples 42-46 optionally include wherein the instructions to determine the gesture include instructions to determine a forearm inclination using the gravity vector.

In Example 48, the subject matter of any one or more of Examples 42-47 optionally include wherein the instructions to determine the gesture include instructions to determine a horizontal angle using the gravity vector and the magnetic field.

In Example 49, the subject matter of any one or more of Examples 42-48 optionally include wherein the gesture includes one of a down tap, a right tap, an out tap, a twist tap, or an omni tap.

In Example 50, the subject matter of any one or more of Examples 42-49 optionally include wherein the instructions for playing sound include instructions for playing a specific instrument corresponding to the gesture.

In Example 51, the subject matter of any one or more of Examples 42-50 optionally include wherein the wearable device is a wrist-worn device.

In Example 52, the subject matter of any one or more of Examples 42-51 optionally include wherein the gravity vector is determined using a weighted average of at least one of the sensor inputs and a previous gravity vector.

In Example 53, the subject matter of any one or more of Examples 42-52 optionally include wherein the magnetic field is determined using a weighted average of at least one of the sensor inputs and a previous magnetic field.

In Example 54, the subject matter of any one or more of Examples 42-53 optionally include wherein the instructions to output the indication include instructions to send the indication to speakers to play the sound.

Example 55 is a system for gesture control, the system comprising: a wearable device including at least one sensor; and processing circuitry to: receive sensor input information from the at least one sensor of the wearable device, the sensor input information including accelerometer data, gyroscope data, and magnetometer data; determine, using the sensor input information, a gravity vector and a magnetic field; determine a change in horizontal angle, rotational angle, or vertical angle based on the sensor input information, the gravity vector, and the magnetic field; determine a gesture based on the change in the horizontal angle, the rotational angle, or the vertical angle; and output an indication, based on the gesture, the indication including instructions for playing sound.

In Example 56, the subject matter of Example 55 optionally includes wherein the processing circuitry is integrated within the wearable device.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMS), read only memories (ROMs), and the like.

What is claimed is:

1. A device for gesture controlled output, the device including processing circuitry to:
receive sensor input information from a wearable device, the sensor input information including accelerometer data, gyroscope data, and magnetometer data;
determine, using the sensor input information, a gravity vector and a magnetic field;
determine a change in horizontal angle, rotational angle, or vertical angle based on the sensor input information, the gravity vector, and the magnetic field;
determine a gesture based on the change in the horizontal angle, the rotational angle, or the vertical angle; and
output an indication, based on the gesture, the indication including instructions for playing sound.

2. The device of claim 1, wherein the processing circuitry is further to determine an initial state of the wearable device and wherein the change in the horizontal angle, the rotational angle, or the vertical angle includes a change from the initial state.

3. The device of claim 1, wherein to determine the gesture, the processing circuitry is to use the accelerometer data to determine a three-axis linear acceleration vector.

4. The device of claim 3, wherein to determine the gesture, the processing circuitry is to determine a directional impulse vector using the three-axis linear acceleration and the gyroscope data.

5. The device of claim 1, wherein to determine the gesture, the processing circuitry is to determine a wrist angle using the gyroscope data and the gravity vector.

6. The device of claim 1, wherein to determine the gesture, the processing circuitry is to determine a forearm inclination using the gravity vector.

7. The device of claim 1, wherein to determine the gesture, the processing circuitry is to determine a horizontal angle using the gravity vector and the magnetic field.

8. The device of claim 1, wherein the gesture includes one of a down tap, a right tap, an out tap, a twist tap, or an omni tap.

9. The device of claim 1, wherein the instructions for playing sound include instructions for playing a specific instrument corresponding to the gesture.

10. The device of claim 1, wherein the wearable device is a wrist-worn device.

11. The device of claim 1, wherein the gravity vector is determined using a weighted average of at least one of the sensor inputs and a previous gravity vector.

12. The device of claim 1, wherein the magnetic field is determined using a weighted average of at least one of the sensor inputs and a previous magnetic field.

13. The device of claim 1, wherein to output the indication, the processing circuitry is to send the indication to speakers to play the sound.

14. A system for gesture control, the system comprising:
a wearable device including at least one sensor; and
processing circuitry to:
receive sensor input information from the at least one sensor of the wearable device, the sensor input information including accelerometer data, gyroscope data, and magnetometer data;
determine, using the sensor input information, a gravity vector and a magnetic field;
determine a change in horizontal angle, rotational angle, or vertical angle based on the sensor input information, the gravity vector, and the magnetic field;
determine a gesture based on the change in the horizontal angle, the rotational angle, or the vertical angle; and
output an indication, based on the gesture, the indication including instructions for playing sound.

15. The system of claim 14, wherein the processing circuitry is integrated within the wearable device.

16. At least one machine-readable medium including instructions for operation of a computing system, which when executed by a machine, cause the machine to:
receive sensor input information from a wearable device, the sensor input information including accelerometer data, gyroscope data, and magnetometer data;
determine, using the sensor input information, a gravity vector and a magnetic field;
determine a change in horizontal angle, rotational angle, or vertical angle based on the sensor input information, the gravity vector, and the magnetic field;
determine a gesture based on the change in the horizontal angle, the rotational angle, or the vertical angle; and
output an indication, based on the gesture, the indication including instructions for playing sound.

17. The at least one machine-readable medium of claim 16, wherein the gesture includes one of a down tap, a right tap, an out tap, a twist tap, or an omni tap.

18. The at least one machine-readable medium of claim 16, wherein the instructions for playing sound include instructions for playing a specific instrument corresponding to the gesture.

19. The at least one machine-readable medium of claim 16, wherein the wearable device is a wrist-worn device.

20. The at least one machine-readable medium of claim 16, wherein the gravity vector is determined using a weighted average of at least one of the sensor inputs and a previous gravity vector.

21. The at least one machine-readable medium of claim 16, further comprising instructions to determine an initial state of the wearable device and wherein the change in the horizontal angle, the rotational angle, or the vertical angle includes a change from the initial state.

22. The at least one machine-readable medium of claim 16, wherein the instructions to determine the change include instructions to use the accelerometer data to determine a three-axis linear acceleration vector.

23. The at least one machine-readable medium of claim 22, wherein the instructions to determine the gesture include instructions to determine a directional impulse vector using the three-axis linear acceleration and the gyroscope data.

24. The at least one machine-readable medium of claim 16, wherein the instructions to determine the gesture include instructions to determine a wrist angle using the gyroscope data and the gravity vector.

25. The at least one machine-readable medium of claim 16, wherein the instructions to determine the gesture include instructions to determine a forearm inclination using the gravity vector.
